(19) United States
(12) Patent Application Publication
(10) Pub. No.: US 2022/0215194 A1
(43) Pub. Date: Jul. 7, 2022

(54) SENSOR AND SENSING METHOD

(71) Applicant: AU Optronics Corporation, HSIN-CHU (TW)

(72) Inventors: Shu-Wen TZENG, HSIN-CHU (TW); Ming-Hung CHUANG, HSIN-CHU (TW)

(21) Appl. No.: 17/509,091

(22) Filed: Oct. 25, 2021

(30) Foreign Application Priority Data
Jan. 7, 2021 (TW) 110100682

(51) Int. Cl. G06K 9/00; H04L 29/08

(52) U.S. Cl. CPC G06K 9/00013; H04L 67/12

(57) ABSTRACT

A sensor device includes a write controlling device, a reset controlling device and a sensing device. The write controlling device generates a first write controlling signal. The first write controlling signal has an enable voltage level during first and second periods, and has a disable voltage level during a third period between the first and second periods. The reset controlling device generates a first reset controlling signal. The first reset controlling signal has an enable voltage level during the third period. The sensing device performs a first sensing operation during the first period to generate a first image signal according to the first write controlling signal, receives a voltage signal during the third period according to the first reset controlling signal, and performs a second sensing operation during the second period to generate a second image signal according to the first write controlling signal.

### CROSS-REFERENCE TO RELATED APPLICATION

This application claims priority to Taiwan Application Serial Number 110100682, filed Jan. 7, 2021, which is herein incorporated by reference in its entirety.

### BACKGROUND

### Technical Field

The present disclosure relates to a sensing technology. More particularly, the present disclosure relates to a sensor and a sensing method.

### Description of Related Art

Fingerprint sensors generate corresponding fingerprint images according to different brightness of fingerprints. However, the fingerprint images are affected by element features of the sensor. As a result, the quality of the fingerprint images is decreased. Thus, techniques associated with the development for overcoming the problems described above are important issues in the field.

### SUMMARY

The present disclosure provides a sensor device including a write controlling device, a reset controlling device and the sensing device. The write controlling device is configured to generate a first write controlling signal. The first write controlling signal has a first enable voltage level during a first period and a second period, and has a first disable voltage level during a third period between the first period and the second period. The reset controlling device is configured to generate a first reset controlling signal. The first reset controlling signal has a second enable voltage level during the third period. The sensing device is configured to perform a first sensing operation during the first period to generate a first image signal according to the first write controlling signal, to receive a voltage signal during the third period according to the first reset controlling signal, and to perform a second sensing operation during the second period to generate a second image signal according to the first write controlling signal.

The present disclosure also provides a sensor including a sensing device. The sensing device is configured to generate a first image signal during a first period based on a voltage level of a first node, to generate a second image signal during a second period based on the voltage level of the first node, and to reset the voltage level of the first node during a third period between the first period and the second period. The sensing device includes a first switch and a sensing element. The first switch is configured to reset the voltage level of the first node, a first terminal of the first switch being coupled to the first node. A first terminal of the sensing element is configured to receive a first write controlling signal, and a second terminal of the sensing element is coupled to the first node. The first write controlling signal has a first enable voltage level during the first period and the second period, and has a first disable voltage level during the third period.

The present disclosure also provides a sensing method, including: generating a first image signal corresponding to surrounding environment and features of a first sensing circuit based on a voltage level of a first node in the first sensing circuit; after the first image signal is generated, pulling a first terminal of a sensing element in the first sensing circuit to a first disable voltage level, a second terminal of the sensing element being coupled to the first node; resetting the voltage level of the first node when the first terminal of the sensing element has the first disable voltage level; and generating a second image signal corresponding to the features of the first sensing circuit based on the voltage level of the first node being reset.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a sensor illustrated according to one embodiment of this disclosure.

FIG. 2 is a circuit diagram of a sensing circuit illustrated according to one embodiment of this disclosure.

FIG. 3 is a timing diagram of a sensing circuit performing sensing operation illustrated according to one embodiment of this disclosure.

FIG. 4 is a timing diagram of a sensor performing sensing operation illustrated according to one embodiment of this disclosure.

FIG. 5 is a schematic diagram of a sensor illustrated according to one embodiment of this disclosure.

FIG. 6 is a timing diagram of a sensor performing sensing operation illustrated according to one embodiment of this disclosure.

FIG. 7 is a circuit diagram of a sensing circuit illustrated according to one embodiment of this disclosure.

FIG. 8 is a timing diagram of a sensing circuit performing sensing operation illustrated according to one embodiment of this disclosure.

FIG. 9 is a timing diagram of a sensing circuit performing sensing operation illustrated according to one embodiment of this disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

Reference will now be made in detail to the present embodiments of the disclosure, examples of which are illustrated in the accompanying drawings. Wherever possible, the same reference numbers are used in the drawings and the description to refer to the same or like parts.

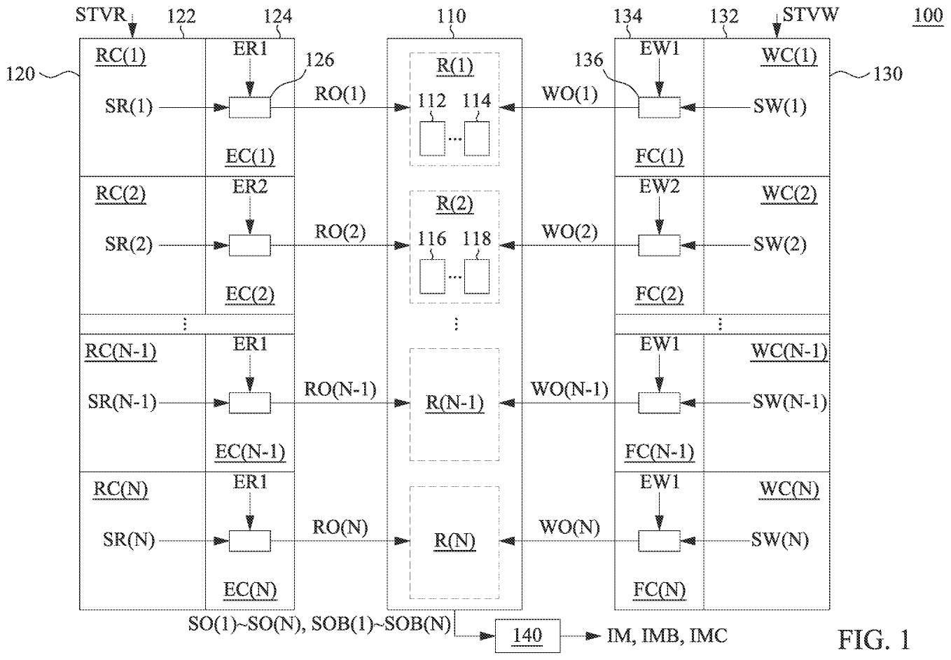

FIG. 1 is a schematic diagram of a sensor 100 illustrated according to one embodiment of this disclosure. In some embodiments, the sensor 100 is configured to sense surrounding environment to generate corresponding images, such as images IM, IMB and IMC described below. For example, when the user puts fingers on the sensor 100, the sensor 100 senses fingerprints of the fingers to generate fingerprint images. In some embodiments, the sensor 100 may be formed by glass substrates or plastic substrates, but not limited thereof.

As illustratively shown in FIG. 1, the sensor 100 includes a sensing device 110, a reset controlling device 120, a write controlling device 130 and a processing device 140. The reset controlling device 120 is configured to generate reset controlling signals RO(1)-RO(N). The write controlling device 130 is configured to generate write controlling signals WO(1)-WO(N). The sensing device 110 is configured to perform sensing operations according to the reset controlling signals RO(1)-RO(N) and the write controlling signals WO(1)-WO(N) to generate image signals SO(1)-SO(N) and SOB(1)-SOB(N). It is noted that N is a positive integer. In some embodiments, the image signals SO(1)-SO(N) and SOB(1)-SOB(N) correspond to the images IM and IMB, respectively, and the difference between the images IM and IMB corresponds to the image IMC.

In various embodiments, the sensing device 110 is configured to perform sensing operations according to a part of the reset controlling signals RO(1)-RO(N) and the write controlling signals WO(1)-WO(N) to generate a part of the image signals SO(1)-SO(N) and SOB(1)-SOB(N).

As illustratively shown in FIG. 1, the reset controlling device 120 includes a reset circuit group 122 and an enable circuit group 124. In some embodiments, the reset circuit group 122 is configured to generate reset signals SR(1)-SR(N). In some embodiments, the reset circuit group 122 is configured to generate the reset signals SR(1)-SR(N) in order according to a signal STVR. In some embodiments, the enable circuit group 124 is configured to generate the reset controlling signals RO(1)-RO(N) according to the reset signals SR(1)-SR(N) and an enable signal ER1.

As illustratively shown in FIG. 1, the reset circuit group 122 includes reset circuits RC(1)-RC(N). In some embodiments, the reset circuits RC(1)-RC(N) are configured to generate the reset signals SR(1)-SR(N), respectively.

As illustratively shown in FIG. 1, the enable circuit group 124 includes enable circuits EC(1)-EC(N). In some embodiments, one of the enable circuits EC(1)-EC(N) is configured to generate a corresponding one of the reset controlling signals RO(1)-RO(N) according to a corresponding one of the reset signals SR(1)-SR(N) and the enable signal ER1, but the embodiments of present disclosure are not limited thereof. Other methods of generating the reset controlling signals RO(1)-RO(N) according to the reset signals SR(1)-SR(N) and the enable signal ER1 are contemplated as being within the scope of the present disclosure.

For example, in the embodiments shown in FIG. 1, the reset circuit RC(1) generates the reset signal SR(1). The enable circuit EC(1) generates the reset controlling signal RO(1) according to the reset signal SR(1) and the enable signal ER1.

In some embodiments, as illustratively shown in FIG. 1, the enable circuit EC(1) further includes a logic circuit 126. The logic circuit 126 is configured to receive the reset signal SR(1) and the enable signal ER1 to output the reset controlling signal RO(1). In some embodiments, the logic circuit 126 includes AND gate, but the embodiments of present disclosure are not limited thereof. In various embodiments, the logic circuit 126 includes different logic elements and combination thereof. In some embodiments, the enable circuits EC(2)-EC(N) include logic circuits configured to receive the reset signals SR(2)-SR(N) and the enable signal ER1 and configured to output the reset controlling signals RO(2)-RO(N).

As illustratively shown in FIG. 1, the write controlling device 130 includes a writing circuit group 132 and an enable circuit group 134. In some embodiments, the writing circuit group 132 is configured to generate writing signals SW(1)-SW(N). In some embodiments, the writing circuit group 132 is configured to generate the writing signals SW(1)-SW(N) in order according to a signal STVW. In some embodiments, the enable circuit group 134 is configured to generate the write controlling signals WO(1)-WO(N) according to the writing signals SW(1)-SW(N) and an enable signal EW1.

As illustratively shown in FIG. 1, the writing circuit group 132 includes writing circuits WC(1)-WC(N). In some embodiments, the writing circuits WC(1)-WC(N) are configured to generate the writing signals SW(1)-SW(N), respectively.

As illustratively shown in FIG. 1, the enable circuit group 134 includes enable circuits FC(1)-FC(N). In some embodiments, one of the enable circuits FC(1)-FC(N) is configured to generate a corresponding one of the write controlling signals WO(1)-WO(N) according to a corresponding one of the writing signals SW(1)-SW(N) and the enable signal EW1, but the embodiments of present disclosure are not limited thereof. Other method of generating the write controlling signals WO(1)-WO(N) according to the writing signals SW(1)-SW(N) and the enable signal EW1 are contemplated as being within the scope of the present disclosure.

For example, in the embodiments shown in FIG. 1, the writing circuit WC(1) generates the writing signal SW(1). The enable circuit FC(1) generates the write controlling signal WO(1) according to the writing signal SW(1) and the enable signal EW1.

In some embodiments, as illustratively shown in FIG. 1, the enable circuit FC(1) further includes a logic circuit 136. The logic circuit 136 is configured to receive the writing signal SW(1) and the enable signal EW1 to output the write controlling signal WO(1). In some embodiments, the logic circuit 136 includes AND gate, but the embodiments of present disclosure are not limited thereof. In various embodiments, the logic circuit 136 includes different logic elements and combination thereof. In some embodiments, the enable circuits FC(2)-FC(N) include logic circuits configured to receive the writing signals SW(2)-SW(N) and the enable signal EW1 and configured to output the write controlling signals WO(2)-WO(N).

As illustratively shown in FIG. 1, the sensing device 110 includes sensing circuit rows R(1)-R(N). In the embodiment shown in FIG. 1, the sensing circuit rows R(1)-R(N) are configured to receive the reset controlling signals RO(1)-RO(N), respectively. The sensing circuit rows R(1)-R(N) are configured to receive the write controlling signals WO(1)-WO(N), respectively.

In some embodiments, each of the sensing circuit rows R(1)-R(N) includes sensing circuits. For example, in the embodiment shown in FIG. 1, the sensing circuit row R(1) includes sensing circuits 112 and 114, and the sensing circuit row R(2) includes sensing circuits 116 and 118, but the embodiments of present disclosure are not limited thereof. In various embodiments, each of the sensing circuit rows R(1)-R(N) may include various numbers of sensing circuits.

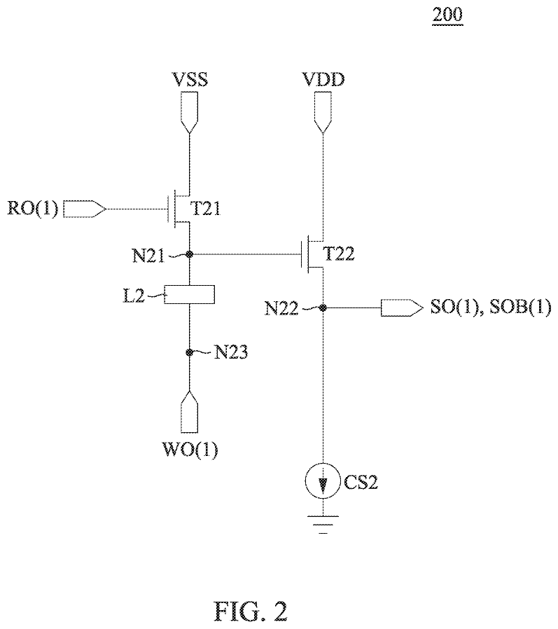

In some embodiments, the sensing circuits 112 and 114 in the sensing circuit row R(1) are configured to perform sensing operations according to the write controlling signal WO(1) and the reset controlling signal RO(1). The sensing circuits 116 and 118 in the sensing circuit row R(2) are configured to perform sensing operations according to the write controlling signal WO(2) and the reset controlling signal RO(2). An example of the sensing circuit 112 performing sensing operations is described below with referring to FIG. 2.

FIG. 2 is a circuit diagram of a sensing circuit illustrated according to one embodiment of this disclosure. Referring to FIG. 2, a sensing circuit 200 is an embodiment of the sensing circuit 112 shown in FIG. 1. In some embodiments, the sensing circuits 114, 116 and 118 have similar element connection relationship of the sensing circuit 200. In some embodiments, one or more sensing circuit in the sensing circuit rows R(1)-R(N) shown in FIG. 1 has similar element connection relationship of the sensing circuit 200.

As illustratively shown in FIG. 2, the sensing circuit 200 includes switches T21, T22, a sensing element L2 and a current source CS2. In some embodiments, elements of the sensing circuit 200 shown in FIG. 2 are included the sensing circuit rows R(1) shown in FIG. 1, but the embodiments of present disclosure are not limited thereof. In other embodiments, the elements of the sensing circuit 200 may be included in devices other than the sensing circuit 200. For example, the current source CS2 may be included in an integrated circuit outside the sensing device 110.

In the embodiments shown in FIG. 2, a control terminal of the switch T21 is configured to receive the reset controlling signal RO(1), a terminal of the switch T21 is configured to receive a voltage signal VSS, another terminal of the switch T21 is coupled to a node N21. A control terminal of the switch T22 is coupled to the node N21, a terminal of the switch T22 is configured to receive a voltage signal VDD, another terminal of the switch T22 is coupled to a node N22. A terminal of the sensing element L2 is coupled to the node N21, another terminal of the sensing element L2 is configured to receive the write controlling signal WO(1). The current source CS2 is coupled to the node N22.

In some embodiments, the sensing element L2 has features of a capacitor, such that a voltage level of the node N21 is increased by the write controlling signal WO(1) via the sensing element L2 when a voltage level of the write controlling signal WO(1) is increased. In some embodiments, the sensing element L2 generates a leakage current according to the brightness of the environment, such that charges from the node N21 flow through the sensing element L2 to the node N23, to change the voltage level of the node N21.

In various embodiments, the sensing element L2 may be a silicon-rich oxide sensing elements or other types of sensing elements. In various embodiments, the switches T21 and T22 may be P-type Metal Oxide Semiconductor (PMOS) transistor, N-type Metal Oxide Semiconductor (NMOS) transistor, thin-film transistor (TFT) or other types of switch elements.

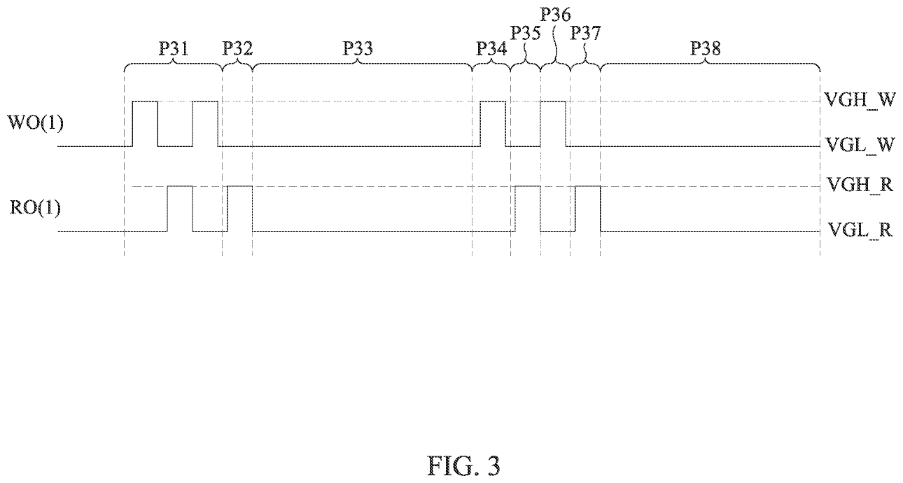

In some embodiments, the sensing element L2 is configured to perform sensing operations according to the write controlling signal WO(1) and the reset controlling signal RO(1), such that the voltage level of the node N21 changes. The switch T22 outputs image signals SO(1) and SOB(1) at the node N22 according to the voltage level of the node N21. An example of the sensing circuit 200 performing sensing operations is described below with referring to FIG. 3.

FIG. 3 is a timing diagram of a sensing circuit performing sensing operation illustrated according to one embodiment of this disclosure. The timing diagram shown in FIG. 3 includes periods P31-P38 in order. In some embodiments, the timing diagram shown in FIG. 3 corresponds to different signals shown in FIG. 2, such as operations of the reset controlling signal RO(1) and the write controlling signal WO(1).

As illustratively shown in FIG. 3, during the period P32, the reset controlling signal RO(1) has an enable voltage level VGH_R, such that the switch T21 is turned on. At this moment, the switch T21 provides a voltage signal VSS having a voltage level SS to the node N21, such that the node N21 has the voltage level SS.

As illustratively shown in FIG. 3, during the period P33, the write controlling signal WO(1) has a disable voltage level VGL_W. At this moment, the sensing element L2 senses the brightness of the environment, such that the voltage level of the node N21 changes gradually according to the brightness of the environment. In some embodiments, during the period P33, the sensing element L2 performs exposure operations according to the brightness of the environment, and thus the period P33 is referred to as an exposure period.

As illustratively shown in FIG. 3, during the period P34, the reset controlling signal RO(1) has a disable voltage level VGL_R, such that the switch T21 is turned off. The write controlling signal WO(1) has an enable voltage level VGH_W, such that the voltage level of the node N21 is increased to turn on the switch T22. At this moment, the voltage level of the node N21 depends on the voltage level SS, the brightness of the environment and related design of parasite capacitors. In some embodiments, during the period P34, the switch T22 generates the image signal SO(1) at the node N22 according to the voltage level of the node N21. In some embodiments, the image signal SO(1) corresponds to a current level of a current passing through the switch T22 during the period P34. In some embodiments, the image signal SO(1) corresponds environment images, such as fingerprint images.

In some embodiments, the image signal SO(1) is affected by the features of the sensing element L2 itself, such as electric features or process features. In some embodiments, the image signal SO(1) is affected by the features of elements in the sensing circuit 200, such as a threshold voltage level V_{TH} of the switch T22.

As illustratively shown in FIG. 3, during the period P35, the reset controlling signal RO(1) has the enable voltage level VGH_R, such that the switch T21 is turned on. The write controlling signal WO(1) has a disable voltage level VGL_W, such that the write controlling signal WO(1) does not affect the voltage level of the node N21 via the sensing element L2. At this moment, the switch T21 provides the voltage signal VSS having the voltage level SS to the node N21, such that the node N21 has the voltage level SS. In some embodiments, the voltage level of the node N21 is reset to the voltage level SS by the voltage signal VSS, and thus the period P35 is referred to as a reset period.

As illustratively shown in FIG. 3, during the period P36, the reset controlling signal RO(1) has the disable voltage level VGL_R, such that the switch T21 is turned off. The write controlling signal WO(1) has the enable voltage level VGH_W, such that the voltage level of the node N21 is increased to turn on the switch T22. In some embodiments, during the period P36, the switch T22 generates the image signal SOB(1) at the node N22 according to the voltage level of the node N21.

In the embodiments shown in FIG. 3, when the reset controlling signal RO(1) is pulled to the disable voltage level VGL_R, the write controlling signal WO(1) is pulled to the enable voltage level VGH_W, such that the sensing element L2 does not generate a leakage current according to the brightness of the environment. In other words, the sensing element L2 is unexposed during the periods P35-P36, and the image signal SOB(1) is not affected by the brightness of the environment. In some embodiments, the image signal SOB(1) is affected by the features of the sensing element L2 and the features of the elements in the sensing circuit 200. In some embodiments, the image signal SOB(1) corresponds to a background image not affected by the brightness of the environment.

As illustratively shown in FIG. 3, during the period P37, the reset controlling signal RO(1) has the enable voltage level VGH_R, such that the switch T21 is turned on. At this moment, the switch T21 provides the voltage signal VSS having the voltage level SS to the node N21, such that the node N21 has the voltage level SS.

As illustratively shown in FIG. 3, during the period P38, the write controlling signal WO(1) has the disable voltage level VGL_W. At this moment, the sensing element L2 generates a leakage current according to the brightness of the environment to perform exposure operations. In some embodiments, after the period P38, the write controlling signal WO(1) is pulled to the enable voltage level VGH_W to generate corresponding image signals.

In the embodiments shown in FIG. 3, operations performed during the period P31 are similar to the operations performed during the periods P34-P36, and thus some detail are not repeated for brevity. In some embodiments, the operations performed during the period P31 are configured to generate image signals before the period P32.

In some other embodiments, the reset controlling signal RO(1) has the disable voltage level VGL_R during the period P32 and/or P37.

Referring to FIG. 3 and FIG. 1, in some embodiments, the processing device 140 is configured to generate the images IM and IMB according to the image signals SO(1) and SOB(1), respectively. In some embodiments, the processing device 140 is further configured to generate the image IMC according to a difference between the images IM and IMB.

In some previous approaches, when a sensor generates images, such as fingerprint images, according to image signals after exposure, background images generated due to features of elements in a sensing circuit are not reduced, such that the images are blurred.

Compared to the above approaches, in some embodiments of the present disclosure, the image IM, such as a fingerprint image, is generated according to the image signal SO(1). The image IM is affected by the brightness of environment and the features of the elements in the sensing circuit 200. The image IMB, such as a background image, is generated according to the image signal SOB(1). The image IMB is affected by the features of the elements in the sensing circuit 200. The image IMC is generated according to the difference between the images IM and IMB. The processing device 140 reduces the image IMB from the image IM, to remove the background image. The image IMC is not affected by the features of the elements in the sensing circuit 200. As a result, by performing the operations described in FIG. 3, the sensor 100 may generate the image IMC with higher clarity.

In some previous approaches, a sensor is configured to store image data corresponding to background before sensing operations, for reducing the stored background image data from a fingerprint image. Those approaches require additional memory devices. Especially, when a size of the sensor is big, costs is increased due to the memory devices configured to store the background image data. Furthermore, features of elements in a sensing circuit may change with respect to time and environment, such that the stored background image data may be biased from the actual condition.

Compared to the above approaches, in some embodiments of the present disclosure, the image signal SO(1) corresponding to a fingerprint image is obtained during the period P34. Then, the image signal SOB(1) corresponding to a background image is obtained during the period P36. As a result, pre-storing a large amount of background image data is not required, and real-time background images are obtained.

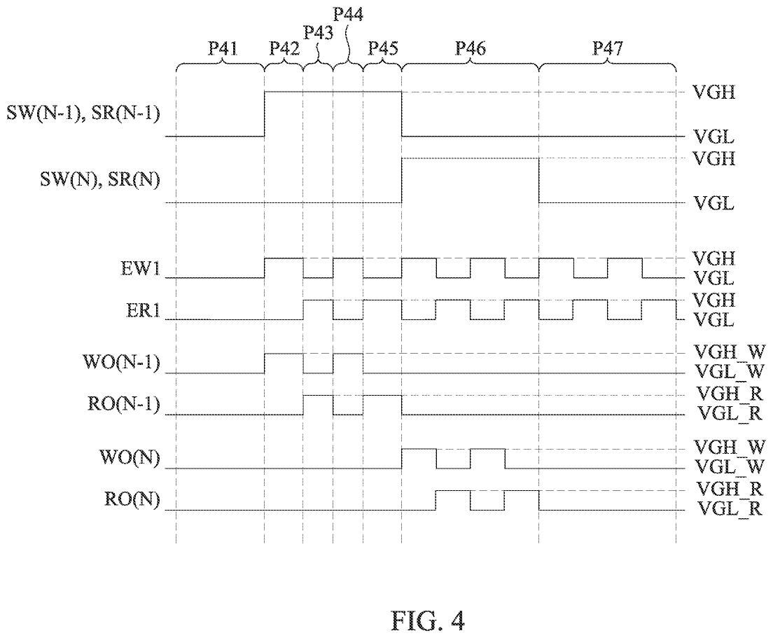

FIG. 4 is a timing diagram of the sensor 100 performing sensing operation illustrated according to one embodiment of this disclosure. The timing diagram shown in FIG. 4 includes periods P41-P48 in order. In some embodiments, the timing diagram shown in FIG. 4 corresponds to different signals shown in FIG. 1, such as operations of the enable signals ER1, EW1, the reset signals SR(N-1), SR(N), the reset controlling signals RO(N-1), RO(N) and the write controlling signals WO(N-1), WO(N).

In some embodiments, when both of the enable signal ER1 and the reset signals SR(N-1) have an enable voltage level VGH, the reset controlling signal RO(N-1) has the enable voltage level VGH_R. When at least one of the enable signal ER1 and the reset signal SR(N-1) has a disable voltage level VGL, the reset controlling signal RO(N-1) has the disable voltage level VGL_R. In some embodiments, the AND gate in the enable circuit EC(N-1) is configured to receive the enable signal ER1 and the reset signal SR(N-1) to output the reset controlling signal RO(N-1).

In some embodiments, when both of the enable signal EW1 and the writing signal SW(N-1) have the enable voltage level VGH, the write controlling signal WO(N-1) has the enable voltage level VGH_W. When at least one of the enable signal EW1 and the writing signal SW(N-1) has the disable voltage level VGL, the write controlling signal WO(N-1) has the disable voltage level VGL_W. In some embodiments, the AND gate in the enable circuit FC(N-1) is configured to receive the enable signal EW1 and the writing signal SW(N-1) to output the write controlling signal WO(N-1).

As illustratively shown in FIG. 4, during the period P41, the writing signal SW(N-1) has the disable voltage level VGL, such that the write controlling signal WO(N-1) has the disable voltage level VGL_W. At this moment, a sensing circuit in the sensing circuit row R(N-1) (for example, the sensing circuit 112 in the sensing circuit row R(1)) is configured to perform the exposure operations.

As illustratively shown in FIG. 4, during the period P42, the writing signal SW(N-1) and the enable signal EW1 have the enable voltage level VGH, such that the write controlling signal WO(N-1) has the enable voltage level VGH_W. The enable signal ER1 has the disable voltage level VGL, such that the reset controlling signal RO(N-1) has the disable voltage level VGL_R. At this moment, the sensing circuit in the sensing circuit row R(N-1) is configured to generate an image signals SO(N-1) corresponding to environment images.

As illustratively shown in FIG. 4, during the period P43, the reset signal SR(N-1) and the enable signal ER1 have the enable voltage level VGH, such that the reset controlling signal RO(N-1) has the enable voltage level VGH_R. The enable signal EW1 has the disable voltage level VGL, such that the write controlling signal WO(N-1) has the disable voltage level VGL_W. At this moment, the sensing circuit in the sensing circuit row R(N-1) is configured to receive a voltage signal, such as the voltage signal VSS shown in FIG. 2, to be reset.

As illustratively shown in FIG. 4, during the period P44, the writing signal SW(N-1) and the enable signal EW1 have the enable voltage level VGH, such that the write controlling signal WO(N-1) has the enable voltage level VGH_W. The enable signal ER1 has the disable voltage level VGL, such that the reset controlling signal RO(N-1) has the disable voltage level VGL_R. At this moment, the sensing circuit in the sensing circuit row R(N-1) is configured to generate an image signals SOB(N-1) corresponding to background images.

As illustratively shown in FIG. 4, during the period P45, the reset signal SR(N-1) and the enable signal ER1 have the enable voltage level VGH, such that the reset controlling signal RO(N-1) has the enable voltage level VGH_R. The enable signal EW1 has the disable voltage level VGL, such that the write controlling signal WO(N-1) has the disable voltage level VGL_W. At this moment, the sensing circuit in the sensing circuit row R(N-1) is configured to receive a voltage signal, such as the voltage signal VSS shown in FIG. 2, to be reset.

In some other embodiments, during the period P45, the enable signal ER1 has the disable voltage level VGL, and the reset controlling signal RO(N-1) has the disable voltage level VGL_R.

In some embodiments, the operations of the write controlling signal WO(N-1) and the reset controlling signal RO(N-1) during the periods P41-P45 are similar with the operations of the write controlling signal WO(1) and the reset controlling signal RO(1) during the periods P33-P37 shown in FIG. 3, and thus some details are not repeated for brevity.

As illustratively shown in FIG. 4, during the period P46, the sensor 100 pulls the write controlling signal WO(N) and the reset controlling signal RO(N) to the respective enable voltage levels VGH/VGH_W/VGH_R or the respective disable voltage levels VGL/VGL_W/VGL_R by the reset signal SR(N), the writing signal SW(N), the enable signal ER1 and EW1. In some embodiments, the operations of the sensor 100 controlling the write controlling signal WO(N) and the reset controlling signal RO(N) by the reset signal SR(N), the writing signal SW(N), the enable signal ER1 and EW1 during the period P46 are similar with the operations of controlling the write controlling signal WO(N-1) and the reset controlling signal RO(N-1) by the reset signal SR(N-1), the writing signal SW(N-1), the enable signal ER1 and EW1 during the periods P42-P45, and thus some details are not repeated for brevity.

In some embodiments, the reset signal SR(N) and the writing signal SW(N) have waveforms similar with those of the reset signal SR(N-1) and the writing signal SW(N-1), respectively. In some embodiments, comparing with the waveforms of the reset signal SR(N-1) and the writing signal SW(N-1), the waveforms of the reset signal SR(N) and the writing signal SW(N) are delayed by a time length corresponding to the periods P42-P45.

As illustratively shown in FIG. 4, during the period P47, the writing signals SW(N-1) and SW(N) have the disable voltage level VGL, such that the write controlling signals WO(N-1) and WO(N) have the disable voltage level VGL_W. At this moment, the sensing circuits in the sensing circuit rows R(N-1) and R(N) are configured to perform the exposure operations.

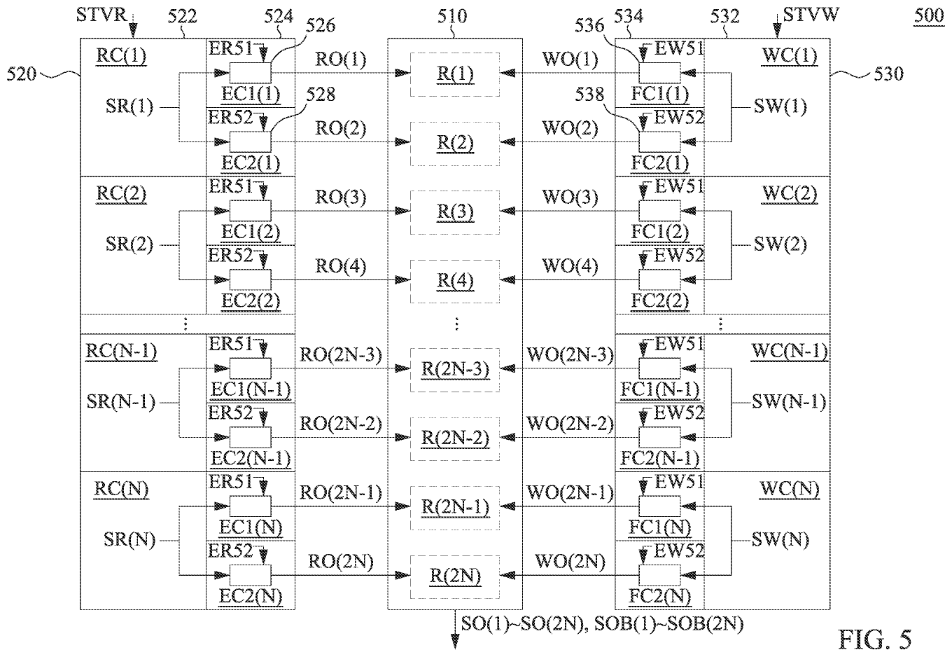

FIG. 5 is a schematic diagram of a sensor 500 illustrated according to one embodiment of this disclosure. The sensor 500 is an alternative embodiment of the sensor 100 shown in FIG. 1.

As illustratively shown in FIG. 5, the sensor 500 includes a sensing device 510, a reset controlling device 520 and a write controlling device 530. The sensing device 510, the reset controlling device 520 and the write controlling device 530 are alternative embodiments of the sensing device 110, the reset controlling device 120 and the write controlling device 130 shown in FIG. 1.

The reset controlling device 520 is configured to generate reset controlling signals RO(1)-RO(2N). The write controlling device 530 is configured to generate write controlling signals WO(1)-WO(2N). The sensing device 510 is configured to perform sensing operations according to the reset controlling signals RO(1)-RO(2N) and the write controlling signals WO(1)-WO(2N) to generate image signals SO(1)-SO(2N) and SOB(1)-SOB(2N). It is noted that N is a positive integer. In various embodiments, the sensing device 510 is configured to perform sensing operations according to a part of the reset controlling signals RO(1)-RO(2N) and the write controlling signals WO(1)-WO(2N) to generate a part of the image signals SO(1)-SO(2N) and SOB(1)-SOB(2N).

In some embodiments, the sensor 500 further includes a processing device (not shown) configured to generate images corresponding to the image signals SO(1)-SO(2N) and SOB(1)-SOB(2N).

As illustratively shown in FIG. 5, the reset controlling device 520 includes a reset circuit group 522 and an enable circuit group 524. In some embodiments, the reset circuit group 522 is configured to generate reset signals SR(1)-SR(N). In some embodiments, the reset circuit group 522 is configured to generate the reset signals SR(1)-SR(N) in order according to a signal STVR. In some embodiments, the enable circuit group 524 is configured to generate the reset controlling signals RO(1)-RO(2N) according to the reset signals SR(1)-SR(N) and an enable signal ER51, ER52.

As illustratively shown in FIG. 5, the reset circuit group 522 includes reset circuits RC(1)-RC(N). In some embodiments, the reset circuits RC(1)-RC(N) are configured to generate the reset signals SR(1)-SR(N), respectively.

As illustratively shown in FIG. 5, the enable circuit group 524 includes enable circuits EC1(1)-EC1(N) and EC2(1)-EC2(N). In some embodiments, one of the enable circuits EC1(1)-EC1(N) is configured to generate a corresponding one of the reset controlling signals RO(1), RO(3), . . . , RO(2N-1) according to a corresponding one of the reset signals SR(1)-SR(N) and the enable signal ER51. One of the enable circuits EC2(1)-EC2(N) is configured to generate a corresponding one of the reset controlling signals RO(2), RO(4), . . . , RO(2N) according to a corresponding one of the reset signals SR(1)-SR(N) and the enable signal ER52.

For example, in the embodiments shown in FIG. 5, the reset circuit RC(1) generates the reset signal SR(1). The enable circuit EC1(1) generates the reset controlling signal RO(1) according to the reset signal SR(1) and the enable signal ER51. The enable circuit EC2(1) generates the reset controlling signal RO(2) according to the reset signal SR(1) and the enable signal ER52.

In some embodiments, as illustratively shown in FIG. 5, the enable circuit EC1(1) further includes a logic circuit 526. The logic circuit 526 is configured to receive the reset signal SR(1) and the enable signal ER51 to output the reset controlling signal RO(1). In some embodiments, as illustratively shown in FIG. 5, the enable circuit EC2(1) further includes a logic circuit 528. The logic circuit 528 is configured to receive the reset signal SR(1) and the enable signal ER52 to output the reset controlling signal RO(2). In some embodiments, each of the logic circuits 526 and 528 includes AND gate, but the embodiments of present disclosure are not limited thereof. In various embodiments, the logic circuits 526 and 528 include different logic elements and combination thereof. In some embodiments, the enable circuits EC1(2)-EC1(N) and EC2(2)-EC2(N) include logic circuits configured to receive the reset signals SR(2)-SR(N) and the enable signals ER51, ER52 and configured to output the reset controlling signals RO(3)-RO(2N).

As illustratively shown in FIG. 5, the write controlling device 530 includes a writing circuit group 532 and an enable circuit group 534. In some embodiments, the writing circuit group 532 is configured to generate writing signals SW(1)-SW(N). In some embodiments, the writing circuit group 532 is configured to generate the writing signals SW(1)-SW(N) in order according to a signal STVW. In some embodiments, the enable circuit group 534 is configured to generate the write controlling signals WO(1)-WO(2N) according to the writing signals SW(1)-SW(N) and an enable signals EW51 and EW52.

As illustratively shown in FIG. 5, the writing circuit group 532 includes writing circuits WC(1)-WC(N). In some embodiments, the writing circuits WC(1)-WC(N) are configured to generate the writing signals SW(1)-SW(N), respectively.

As illustratively shown in FIG. 5, the enable circuit group 534 includes enable circuits FC1(1)-FC1(N) and FC2(1)-FC2(N). In some embodiments, one of the enable circuits FC1(1)-FC1(N) is configured to generate a corresponding one of the write controlling signals WO(1), WO(3), . . . , WO(2N-1) according to a corresponding one of the writing signals SW(1)-SW(N) and the enable signal EW51. One of the enable circuits FC2(1)-FC2(N) is configured to generate a corresponding one of the write controlling signals WO(2), WO(4), . . . , WO(2N) according to a corresponding one of the writing signals SW(1)-SW(N) and the enable signal EW52.

For example, in the embodiments shown in FIG. 5, the writing circuit WC(1) generates the writing signal SW(1). The enable circuit FC1(1) generates the write controlling signal WO(1) according to the writing signal SW(1) and the enable signal EW51. The enable circuit FC2(1) generates the write controlling signal WO(2) according to the writing signal SW(1) and the enable signal EW52.

In some embodiments, as illustratively shown in FIG. 5, the enable circuit FC1(1) further includes a logic circuit 536. The logic circuit 536 is configured to receive the writing signal SW(1) and the enable signal EW51 to output the write controlling signal WO(1). In some embodiments, as illustratively shown in FIG. 5, the enable circuit FC2(1) further includes a logic circuit 538. The logic circuit 538 is configured to receive the writing signal SW(1) and the enable signal EW52 to output the write controlling signal WO(2). In some embodiments, the logic circuits 536 and 538 include AND gate, but the embodiments of present disclosure are not limited thereof. In various embodiments, the logic circuits 536 and 538 include different logic elements and combination thereof. In some embodiments, the enable circuits FC1(2)-FC1(N) and FC2(2)-FC2(N) include logic circuits configured to receive the writing signals SW(2)-SW(N) and the enable signals EW51, EW52, and configured to output the write controlling signals WO(3)-WO(2N).

As illustratively shown in FIG. 5, the sensing device 510 includes sensing circuit rows R(1)-R(2N). In the embodiment shown in FIG. 5, the sensing circuit rows R(1)-R(2N) are configured to receive the reset controlling signals RO(1)-RO(2N), respectively. The sensing circuit rows R(1)-R(2N) are configured to receive the write controlling signals WO(1)-WO(2N), respectively.

In some embodiments, each of the sensing circuit rows R(1)-R(2N) includes sensing circuits. In various embodiments, each of the sensing circuit rows R(1)-R(2N) may include various numbers of sensing circuits.

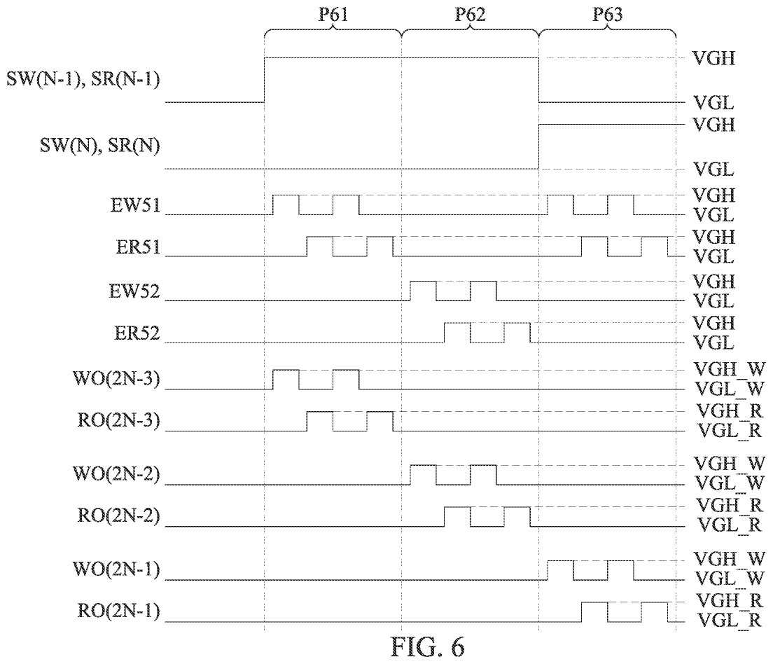

FIG. 6 is a timing diagram of the sensor 500 performing sensing operation illustrated according to one embodiment of this disclosure. The timing diagram shown in FIG. 6 includes periods P61-P63 in order. In some embodiments, the timing diagram shown in FIG. 6 corresponds to different signals shown in FIG. 5, such as operations of the enable signals ER51,ER52, EW51, EW52, the reset signals SR(N-1), SR(N), the reset controlling signals RO(2N-1), RO(2N-2), RO(2N-3) and the write controlling signals WO(2N-1), WO(2N-2), WO(2N-3).

In some embodiments, when both of the enable signal ER51 and the reset signals SR(N-1) have an enable voltage level VGH, the reset controlling signal RO(2N-3) has the enable voltage level VGH_R. When at least one of the enable signal ER51 and the reset signal SR(N-1) has a disable voltage level VGL, the reset controlling signal RO(2N-3) has the disable voltage level VGL_R. In some embodiments, the AND gate in the enable circuit EC1(N-1) is configured to receive the enable signal ER51 and the reset signal SR(N-1) to output the reset controlling signal RO(2N-3).

In some embodiments, when both of the enable signal EW51 and the writing signal SW(N-1) have the enable voltage level VGH, the write controlling signal WO(2N-3) has the enable voltage level VGH_W. When at least one of the enable signal EW51 and the writing signal SW(N-1) has the disable voltage level VGL, the write controlling signal WO(2N-3) has the disable voltage level VGL_W. In some embodiments, the AND gate in the enable circuit FC1(N-1) is configured to receive the enable signal EW51 and the writing signal SW(N-1) to output the write controlling signal WO(2N-3).

In some embodiments, when both of the enable signal ER52 and the reset signals SR(N-1) have an enable voltage level VGH, the reset controlling signal RO(2N-2) has the enable voltage level VGH_R. When at least one of the enable signal ER52 and the reset signal SR(N-1) has a disable voltage level VGL, the reset controlling signal RO(2N-2) has the disable voltage level VGL_R. In some embodiments, the AND gate in the enable circuit EC2(N-1) is configured to receive the enable signal ER52 and the reset signal SR(N-1) to output the reset controlling signal RO(2N-2).

In some embodiments, when both of the enable signal EW52 and the writing signal SW(N-1) have the enable voltage level VGH, the write controlling signal WO(2N-2) has the enable voltage level VGH_W. When at least one of the enable signal EW52 and the writing signal SW(N-1) has the disable voltage level VGL, the write controlling signal WO(2N-2) has the disable voltage level VGL_W. In some embodiments, the AND gate in the enable circuit FC2(N-1) is configured to receive the enable signal EW52 and the writing signal SW(N-1) to output the write controlling signal WO(2N-2).

As illustratively shown in FIG. 6, during the period P61, the writing signal SW(N-1) and the reset signal SR(N-1) have the enable voltage level VGH, such that the write controlling signal WO(2N-3) and the reset controlling signal RO(2N-3) are adjust to respective voltage levels according to the enable signals EW51 and ER51, respectively.

In some embodiments, the operations of the writing signal SW(N-1), the reset signal SR(N-1), the enable signals EW51, ER51, the write controlling signal WO(2N-3) and the reset controlling signal RO(2N-3) during the period P61 are similar with the operations of the writing signal SW(N-1), the reset signal SR(N-1), the enable signals EW1, ER1, the write controlling signal WO(N-1) and the reset controlling signal RO(N-1) during the periods P42-P45 shown in FIG. 4, and thus some details are not repeated for brevity.

As illustratively shown in FIG. 6, during the period P62, the writing signal SW(N-1) and the reset signal SR(N-1) have the enable voltage level VGH, such that the write controlling signal WO(2N-2) and the reset controlling signal RO(2N-2) are adjust to respective voltage levels according to the enable signals EW52 and ER52, respectively.

In some embodiments, the operations of the writing signal SW(N-1), the reset signal SR(N-1), the enable signals EW52, ER52, the write controlling signal WO(2N-2) and the reset controlling signal RO(2N-2) during the period P62 are similar with the operations of the writing signal SW(N-1), the reset signal SR(N-1), the enable signals EW1, ER1, the write controlling signal WO(N-1) and the reset controlling signal RO(N-1) during the periods P42-P45 shown in FIG. 4, and thus some details are not repeated for brevity.

As illustratively shown in FIG. 6, during the period P63, the writing signal SW(N) and the reset signal SR(N) have the enable voltage level VGH, such that the write controlling signal WO(2N-1) and the reset controlling signal RO(2N-1) are adjust to respective voltage levels according to the enable signals EW51 and ER51, respectively.

In some embodiments, waveforms of the enable signals EW52, ER52 correspond to waveforms of the enable signals EW51, ER51 delayed by a time length of the period P61, respectively.

In some embodiments, the operations of the writing signal SW(N), the reset signal SR(N), the enable signals EW51, ER51, the write controlling signal WO(2N-1) and the reset controlling signal RO(2N-1) during the period P63 are similar with the operations of the writing signal SW(N-1), the reset signal SR(N-1), the enable signals EW1, ER1, the write controlling signal WO(N-1) and the reset controlling signal RO(N-1) during the periods P42-P45 shown in FIG. 4, and thus some details are not repeated for brevity.

In some embodiments, during the periods P61-P62, the sensor 500 generates two write controlling signals WO(2N-3) and WO(2N-2) based on one writing signal SW(N-1) and two enable signals EW51, EW52, and generates two reset controlling signals RO(2N-3) and RO(2N-2) based on one reset signal SR(N-1) and two enable signals ER51, ER52, but embodiments of present disclosure are not limited to this. In various embodiments, methods of generating various numbers of write controlling signals and reset controlling signals based on various numbers of writing signals, reset signals and enable signals are contemplated as being within the scope of the present disclosure.

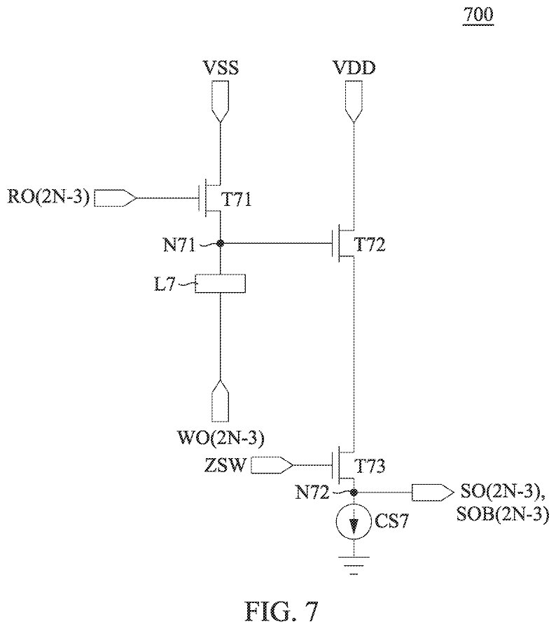

FIG. 7 is a circuit diagram of a sensing circuit 700 illustrated according to one embodiment of this disclosure. Referring to FIG. 7 and FIG. 5, the sensing circuit 700 is an embodiment of one or more sensing circuit in the sensing circuit rows R(1)-R(2N) shown in FIG. 5.

As illustratively shown in FIG. 7, the sensing circuit 700 includes switches T71-T73, a sensing element L7 and a current source CS7.

Referring to FIG. 2 and FIG. 7, in some embodiments, configurations of the switches T71, T72 and the sensing element L7 are similar with configurations of the switches T21, T22 and the sensing element L2, and thus some details are not repeated for brevity.

As illustratively shown in FIG. 7, a terminal of the switch T73 is coupled to the switch T72, and another terminal of the switch T73 is coupled to the current source CS7 at a node N72, a control terminal of the switch T73 is configured to receive a switch signal ZSW.

In embodiments shown in FIG. 7, the sensing circuit 700 is included in the sensing circuit row R(2N-3), and is configured to operate according to the write controlling signal WO(2N-3) and the reset controlling signal RO(2N-3) to generate the image signal SO(2N-3) and SOB(2N-3). In various embodiments, the sensing circuit 700 is included in one of the sensing circuit rows R(1)-R(2N), and operates according to a corresponding one of the write controlling signals WO(1)-WO(2N) and a corresponding one of the reset controlling signal RO(1)-RO(2N).

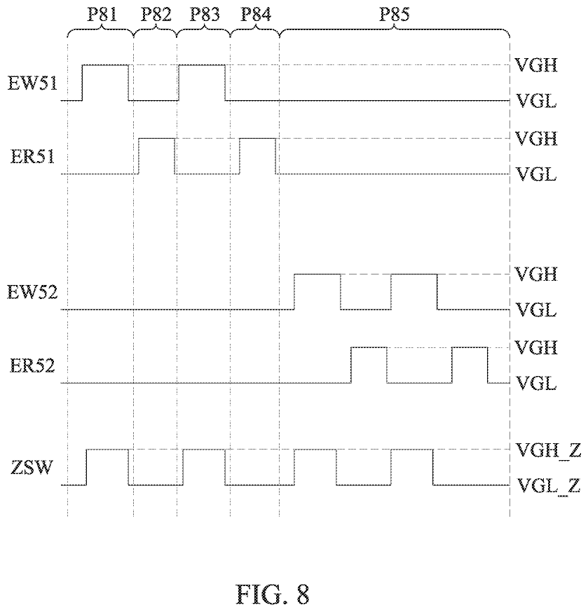

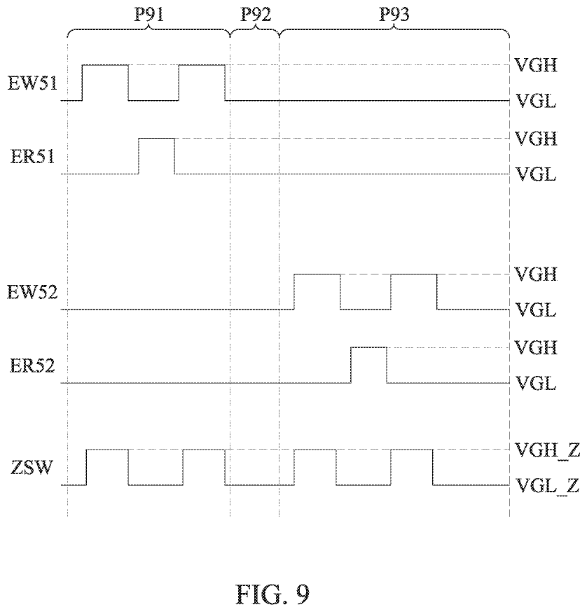

Referring to FIG. 6 and FIG. 7, the voltage levels of the write controlling signals WO(1)-WO(2N) and the reset controlling signal RO(1)-RO(2N) are adjusted according to the enable signals ER51, ER52, EW51 and EW52. In some embodiments, the sensing circuit 700 is configured to operate according to corresponding two of the enable signals ER51, ER52, EW51 and EW52 and the switch signal ZSW. Further details of operations of the sensing circuit 700 are described below referring to FIG. 8 and FIG. 9.

FIG. 8 is a timing diagram of the sensing circuit 700 performing sensing operation illustrated according to one embodiment of this disclosure. The timing diagram shown in FIG. 8 includes periods P81-P85 in order.

Referring to FIG. 7 and FIG. 8, during the period P81, the enable signal EW51 has the enable voltage level VGH, such that the write controlling signal WO(2N-3) has the enable voltage level VGH_W, and the switch T73 is turned on. At this moment, the voltage level of the node N71 is increased, the switch signal ZSW has a enable voltage level VGH_Z and the current source CS7 generate a current passing through the node N72 to generate the image signal SO(2N-3).

During the period P82, the enable signal ER51 has the enable voltage level VGH, such that the reset controlling signal RO(2N-3) has the enable voltage level VGH_R, and the switch signal ZSW has a disable voltage level VGL_Z, such that the switch T73 is turned off. At this moment, the write controlling signal WO(2N-3) has the disable voltage level VGL_W. At this moment, a voltage signal VSS is provided to the node N71 to reset a voltage level of the node N71.

During the period P83, the enable signal EW51 has the enable voltage level VGH, such that the write controlling signal WO(2N-3) has the enable voltage level VGH_W, and the switch signal ZSW has the enable voltage level VGH_Z, such that the switch T73 is turned on. At this moment, the voltage level of the node N71 is increased, and the current source CS7 generate a current passing through the node N72 to generate the image signal SOB(2N-3).

During the period P84, the enable signal ER51 has the enable voltage level VGH, such that the reset controlling signal RO(2N-3) has the enable voltage level VGH_R, and the switch signal ZSW has a disable voltage level VGL_Z, such that the switch T73 is turned off. At this moment, the voltage signal VSS is provided to the node N71 to reset a voltage level of the node N71.

During the period P85, the reset controlling signal RO(2N-3) has the disable voltage level VGL_R and the write controlling signal WO(2N-3) has the disable voltage level VGL_W, such that the sensing circuit 700 performs the exposure operations.

In some embodiments, the operations of the enable signal ER52 and EW52 correspond to the sensing circuits in the sensing circuit row R(2N-2) shown in FIG. 5. In some embodiments, operations of the switch signal ZSW, the enable signal ER52 and EW52 during the period P85 are similar to the operations of the switch signal ZSW, the enable signal ER51 and EW51 during the periods P81-P84, and thus some detail are not repeated for brevity.

In some embodiments, operations of the enable signal ER51, EW51, ER52 and EW52 during the periods P81-P85 are similar to the operations of the enable signal ER51, EW51, ER52 and EW52 during the periods P61-P62 shown in FIG. 6, and thus some detail are not repeated for brevity.

FIG. 9 is a timing diagram of the sensing circuit 700 performing sensing operation illustrated according to one embodiment of this disclosure. The timing diagram shown in FIG. 9 includes periods P91-P93 in order.

In some embodiments, operations of the enable signal ER51, EW51, ER52 and EW52 during the period P91 are similar to the operations of the enable signal ER51, EW51, ER52 and EW52 during the periods P81-P83 shown in FIG. 8, and thus some detail are not repeated for brevity.

In some embodiments, operations of the switch signal ZSW, the enable signal ER52 and EW52 during the period P93 are similar to the operations of the switch signal ZSW, the enable signal ER51 and EW51 during the periods P91-P92, and thus some detail are not repeated for brevity.

In various embodiments, users may select waveforms of the enable signal ER51 and/or ER52 shown in FIG. 8 and FIG. 9 according to various specifications of circuits.

In summary, in embodiments of present disclosure, the sensor 100 generates the reset controlling signals RO(1)-RO(N) and the write controlling signals WO(1)-WO(N) having the waveforms shown in FIG. 3 to generate the image IMC without background effects. Furthermore, in embodiments of present disclosure, various configurations of generating the reset controlling signals RO(1)-RO(N) and the write controlling signals WO(1)-WO(N) based on the enable signals (such as the enable signals ER1, EW1, ER51, ER52, EW51 and EW52), the writing signals SW(1)-SW(N) and the reset signals SR(1)-SR(N) are disclosed.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A sensor comprising:
a write controlling device configured to generate a first write controlling signal, wherein the first write controlling signal has a first enable voltage level during a first period and a second period, and has a first disable voltage level during a third period between the first period and the second period;
a reset controlling device configured to generate a first reset controlling signal, wherein the first reset controlling signal has a second enable voltage level during the third period; and
a sensing device configured to perform a first sensing operation during the first period to generate a first image signal according to the first write controlling signal, configured to receive a voltage signal at the third period according to the first reset controlling signal, and configured to perform a second sensing operation during the second period to generate a second image signal according to the first write controlling signal.

2. The sensor of claim 1, wherein the sensing device comprises:
a first switch, a control terminal of the first switch configured to receive the first reset controlling signal, to transmit the voltage signal to a first node during the third period;
a second switch configured to output the first image signal and the second image signal according to a voltage level of the first node, a control terminal of the second switch being coupled to a first terminal of the first switch at the first node; and
a sensing element configured to receive the write controlling signal, and coupled to the first node.

3. The sensor of claim 2, wherein the sensing device further comprises:
a third switch coupled between a first terminal of the second switch and a current source, and configured to be turned on during the first period and the second period.

4. The sensor of claim 2, wherein the first switch is further configured to transmit the voltage signal to the first node according to the first reset controlling signal during a fourth period after the second period.

5. The sensor of claim 2, further comprising:
a processing device configured to generate a first image according to the first image signal, configured to generate a second image according to the second image signal, and configured to generate a third image according to a difference between the first image and the second image.

6. The sensor of claim 1, wherein the write controlling device comprises:
a writing circuit configured to generate a writing signal having a third enable voltage level during the first period, the second period and the third period; and
an enable circuit configured to generate the first write controlling signal according to the writing signal and an enable signal, wherein the enable signal has the third enable voltage level during the second period, and has a second disable voltage level during the third period.

7. The sensor of claim 1, wherein the reset controlling device comprises:
a circuit configured to generate a reset signal having a third enable voltage level during the first period, the second period and the third period; and
an enable circuit configured to generate the first reset controlling signal according to the reset signal and an enable signal, wherein the enable signal has a second disable voltage level during the first period and the second period, and has the third enable voltage signal during the third period.

8. The sensor of claim 1, wherein
the sensing device comprises:
a first sensing circuit configured to generate the first image signal and the second image signal according to the first write controlling signal; and
a second sensing circuit configured to operate according to a second write controlling signal; and
the write controlling device comprises:
a writing circuit configured to generate a first writing signal having a third enable voltage level during the first period, the second period, the third period, a fourth period, a fifth period and a sixth period, the fourth period, the fifth period and the sixth period being arranged in order after the second period;
a first enable circuit configured to generate the first write controlling signal according to the first writing signal and a first enable signal, wherein the first enable signal has the third enable voltage level during the first period and the second period, and has a second disable voltage level during the third period; and
a second enable circuit configured to generate the second write controlling signal according to the first writing signal and a second enable signal, wherein the second enable signal has the third enable voltage level during the fourth period and the sixth period, and has the second disable voltage level during the fifth period.

9. The sensor of claim 8, wherein the reset controlling device comprises:
a circuit configured to generate a reset signal having the third enable voltage level during the first period, the second period, the third period, the fourth period, the fifth period and the sixth period;
a third enable circuit configured to generate the first reset controlling signal according to the reset signal and a third enable signal, wherein the third enable signal has the second disable voltage level during the first period and the second period, and has the third enable voltage signal during the third period; and
a fourth enable circuit configured to generate a second reset controlling signal according to the reset signal and a fourth enable signal, wherein the fourth enable signal has the second disable voltage level during the fourth period and the sixth period, and has the third enable voltage signal during the fifth period,
wherein the second sensing circuit is configured to receive the voltage signal according to the second reset controlling signal.

10. The sensor of claim 8, wherein
the writing circuit is further configured to generate a second writing signal, wherein the second writing signal has the second disable voltage level during the first period, the second period, the third period, the fourth period, the fifth period and the sixth period, and has the third enable voltage level during a seventh period, an eighth period and a ninth period, the seventh period, the eighth period and the ninth period are arranged in order after the sixth period;
the sensing device comprises:
a third sensing circuit configured to operate according to a third write controlling signal; and
the write controlling device comprises:
a third enable circuit configured to generate the third write controlling signal according to the second writing signal and the first enable signal,
wherein the first enable signal has the third enable voltage level during the seventh period and the ninth period, and has the second disable voltage during the eighth period.

11. A sensor comprising:
a sensing device configured to generate a first image signal during a first period based on a voltage level of a first node, configured to generate a second image signal during a second period based on the voltage level of the first node, and configured to reset the voltage level of the first node during a third period between the first period and the second period, the sensing device comprising:
a first switch configured to reset the voltage level of the first node, a first terminal of the first switch being coupled to the first node; and
a sensing element, a first terminal of the sensing element being configured to receive a first write controlling signal, and a second terminal of the sensing element being coupled to the first node,
wherein the first write controlling signal has a first enable voltage level during the first period and the second period, and has a first disable voltage level during the third period.

12. The sensor of claim 11, further comprising:
a writing circuit configured to generate a first writing signal having a second enable voltage level during the first period, the second period and the third period; and
an enable circuit configured to generate the first write controlling signal according to the first writing signal and an enable signal, wherein the enable signal has the second enable voltage level during the first period and the second period, and has a second disable voltage level during the third period.

13. The sensor of claim 12, wherein
the sensing device further comprises:
a first sensing circuit comprising the first switch and the sensing element, and configured to generate the first image signal and the second image signal according to the first write controlling signal having the second enable voltage level during a fourth period, a fifth period and a sixth period, the fourth period, the fifth period and the sixth period being arranged in order after the second period; and
a second sensing circuit configured to operate according to a second write controlling signal; and
a second enable circuit configured to generate the second write controlling signal according to the first writing signal and a second enable signal,
wherein the second enable signal has the second enable voltage level during the fourth period and the sixth period, and has the second disable voltage during the fifth period.

14. The sensor of claim 13, wherein the writing circuit is further configured to generate a second writing signal, and
the second writing signal has the second disable voltage level during the first period, the second period, the third period, the fourth period, the fifth period and the sixth period, and has the second enable voltage level during a seventh period, an eighth period and a ninth period, the seventh period, the eighth period and the ninth period are arranged in order after the sixth period;
the sensing device further comprises:
a third sensing circuit configured to operate according to a third write controlling signal; and
the write controlling device comprises:
a third enable circuit configured to generate the third write controlling signal according to the second writing signal and the first enable signal,
wherein the first enable signal has the second enable voltage level during the seventh period and the ninth period, and has the second disable voltage during the eighth period.

15. The sensor of claim 13, wherein the first sensing circuit further comprises:
a second switch configured to output the first image signal and the second image signal according to the voltage level of the first node, a control terminal of the second switch being coupled to the first node.

16. The sensor of claim 15, wherein the first sensing circuit further comprises:
a third switch coupled between a first terminal of the second switch and a current source, and configured to be turned off during the third period.

17. A sensing method, comprising:
generating a first image signal corresponding to surrounding environment and features of a first sensing circuit based on a voltage level of a first node in the first sensing circuit;
after the first image signal is generated, pulling a first terminal of a sensing element in the first sensing circuit to a first disable voltage level, a second terminal of the sensing element being coupled to the first node;
resetting the voltage level of the first node when the first terminal of the sensing element has the first disable voltage level; and
generating a second image signal corresponding to the features of the first sensing circuit based on the voltage level of the first node being reset.

18. The sensing method of claim 17, further comprising:
generating a first image based on the first image signal; and
removing the features of the first sensing circuit from the first image based on the second image signal to generate a second image which is independent from the features of the first sensing circuit.

19. The sensing method of claim 17, wherein resetting the voltage level of the first node comprises:
transmitting a voltage signal to the first node by a switch; and
receiving a reset controlling signal by a control terminal of the switch, wherein the reset controlling signal has a first enable voltage level when resetting the voltage level of the first node, and has a first disable voltage level when generating the first image signal and when generating the second image signal.

20. The sensing method of claim 19, further comprising:
transmitting the voltage signal to the first node by the switch after the second image signal is generated.
